(19) United States
(12) Patent Application Publication
(10) Pub. No.: US 2020/0150497 A1
(43) Pub. Date: May 14, 2020

(54) LIQUID CRYSTAL DISPLAY DEVICE

(71) Applicant: SHARP KABUSHIKI KAISHA, Osaka (JP)

(72) Inventors: SHOGO NISHIWAKI, Osaka (JP); TAKAHIRO NEMOTO, Osaka (JP); KATSUHIKO MORISHITA, Osaka (JP); HISASHI NAGATA, Osaka (JP); MASATOSHI ITOH, Osaka (JP)

(21) Appl. No.: 16/682,504

(22) Filed: Nov. 13, 2019

Related U.S. Application Data
(60) Provisional application No. 62/767,357, filed on Nov. 14, 2018.

(51) Int. Cl. G02F 1/1343; G02F 1/1337

(52) U.S. Cl. CPC G02F 1/134363; G02F 1/1368; G02F 1/133707

(57) ABSTRACT

A liquid crystal display device includes: a first substrate; a second substrate; and a liquid crystal layer that contains liquid crystal molecules. The first substrate includes, in the following order toward the liquid crystal layer, a bus line extending in a first direction, a first electrode, an insulating layer, and a second electrode. The second electrode is provided with a longitudinal portion extending in a second direction in a pixel region. The initial alignment direction of the liquid crystal molecules and the second direction satisfy the following relation (A) or (B): (A) the initial alignment direction of the liquid crystal molecules is at an angle of 0° to +5° and the second direction is at a negative angle; and (B) the initial alignment direction of the liquid crystal molecules is at an angle of −5° to 0° and the second direction is at a positive angle.

### CROSS-REFERENCE TO RELATED APPLICATIONS

The present application claims priority under 35 U.S.C. § 119 to U.S. Provisional Application No. 62/767,357 filed on Nov. 14, 2018, the contents of which are incorporated herein by reference in their entirety.

### BACKGROUND OF THE INVENTION

### Field of the Invention

The present invention relates to liquid crystal display devices.

### Description of Related Art

Liquid crystal display devices are display devices that use a liquid crystal layer (liquid crystal molecules) for displaying images (e.g., JP 2017-26874 A). A typical liquid crystal display device provides display by irradiating a liquid crystal layer sandwiched between a pair of substrates with light from a backlight, applying voltage to the liquid crystal layer to change the alignment of liquid crystal molecules, and thereby controlling the amount of light transmitting the liquid crystal layer.

### BRIEF SUMMARY OF THE INVENTION

Recently, many liquid crystal display devices employ the fringe field switching (FFS) mode, which is a kind of the transverse electric field mode, because this mode tends to achieve wide viewing angle characteristics. Unfortunately, some conventional FFS mode liquid crystal display devices have a low response speed when, for example, the grayscale level for display is changed from level 0 to level 96 or 127.

In response to this issue, the present inventors found through studies that increasing an angle formed by the initial alignment direction of liquid crystal molecules and the extending direction of the pixel electrode effectively achieves a higher response speed. Some FFS mode liquid crystal display devices include a thin-film transistor array substrate as a back surface side substrate functioning as one of paired substrates sandwiching the liquid crystal layer. When linearly polarized light having passed through a linearly polarizing plate (absorptive polarizing plate) disposed on the back surface side of the thin-film transistor array substrate is incident on the thin-film transistor array substrate, the light is polarized in the direction parallel or perpendicular to the initial alignment direction of the liquid crystal molecules. Thus, the polarized direction of the linearly polarized light incident on the thin-film transistor array substrate is inclined to a bus line (gate bus line or source bus line) that extends in a different direction from the initial alignment direction of the liquid crystal molecules. The inventors also found the following through further studies. That is, when this inclination angle is increased (e.g., brought close to 45°) in order to increase the response speed, the phenomenon of the ray system may occur to cause light leakage along the bus line in the black display state (with no voltage applied to the liquid crystal layer) of the liquid crystal display device, possibly resulting in a reduced contrast ratio.

Conventional FFS mode liquid crystal display devices thus have an aim of improving both the response speed and the contrast ratio. Unfortunately, the technique disclosed in JP 2017-26874 A, for example, still has room for achieving such an aim.

The present invention has been made under the current situation in the art and aims to provide a liquid crystal display device capable of improving both the response speed and the contrast ratio.

(1) An aspect of the present invention is a liquid crystal display device including: a first substrate; a second substrate facing the first substrate; and a liquid crystal layer that is sandwiched between the first substrate and the second substrate and contains liquid crystal molecules, the first substrate including, in the following order toward the liquid crystal layer, a bus line extending in a first direction, a first electrode, an insulating layer, and a second electrode, the second electrode being provided with a longitudinal portion extending in a second direction in a pixel region, an initial alignment direction of the liquid crystal molecules and the second direction satisfying the following relation (A) or (B) when an angle is defined to be positive in a clockwise direction with the first direction taken as a reference: (A) the initial alignment direction of the liquid crystal molecules is at an angle of 0° to +5° and the second direction is at a negative angle; and (B) the initial alignment direction of the liquid crystal molecules is at an angle of −5° to 0° and the second direction is at a positive angle.

(2) In an embodiment of the present invention, the liquid crystal display device includes the structure (1) and the longitudinal portion is part of an electrode portion of the second electrode.

(3) In an embodiment of the present invention, the liquid crystal display device includes the structure (1) and the longitudinal portion is part of an aperture formed in the second electrode.

(4) In an embodiment of the present invention, the liquid crystal display device includes any one of the structures (1) to (3) and the first direction and the second direction form an angle of greater than 0° and 10° or smaller.

(5) In an embodiment of the present invention, the liquid crystal display device includes any one of the structures (1) to (4) and the initial alignment direction of the liquid crystal molecules and the second direction form an angle of 10° to 15°.

The present invention can provide a liquid crystal display device capable of improving both the response speed and the contrast ratio.

### BRIEF DESCRIPTION OF THE DRAWINGS

FIG. 1 is a schematic cross-sectional view showing a liquid crystal display device of Embodiment 1.

FIG. 2 is a schematic plan view showing part of a first substrate in FIG. 1.

FIG. 3 is a schematic cross-sectional view showing a liquid crystal display device of a comparative example to Embodiment 1.

FIG. 4 is a schematic plan view showing part of a first substrate in FIG. 3.

FIG. 5 is a schematic plan view showing part of a first substrate in a liquid crystal display device of Embodiment 2.

FIG. 6 is a schematic plan view showing part of a first substrate in a liquid crystal display device of a comparative example to Embodiment 2.

### DETAILED DESCRIPTION OF THE INVENTION

The present invention is described below in more detail based on embodiments with reference to the drawings. The embodiments, however, are not intended to limit the scope of the present invention. The configurations employed in the embodiments may appropriately be combined or modified within the spirit of the present invention.

Herein, “X to Y” means “X or more and Y or less”.

### Embodiment 1

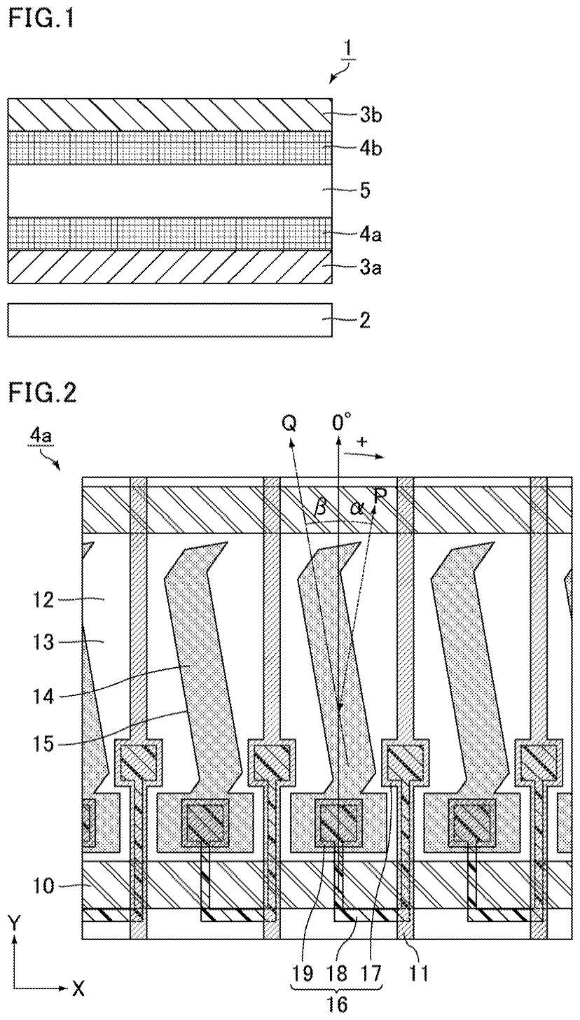

FIG. 1 is a schematic cross-sectional view showing a liquid crystal display device of Embodiment 1. As shown in FIG. 1, a liquid crystal display device 1 includes, in the following order from the back surface side to the viewing surface side, a backlight 2, a first linearly polarizing plate 3a, a first substrate 4a, a liquid crystal layer 5, a second substrate 4b, and a second linearly polarizing plate 3b. The first substrate 4a and the second substrate 4b face each other. The liquid crystal layer 5 is sandwiched between the first substrate 4a and the second substrate 4b that are bonded with a sealant.

The “viewing surface side” herein means a side closer to the screen of the liquid crystal display device and in FIG. 1, for example, the upper side (second linearly polarizing plate 3b side) of the liquid crystal display device 1. The “back surface side” herein means a side remote from the screen of the liquid crystal display device and in FIG. 1, for example, the lower side (backlight 2 side) of the liquid crystal display device 1.

### <Backlight>

The backlight 2 may be an edge-lit backlight or a direct-lit backlight, for example. The light source of the backlight 2 may be light emitting diodes (LEDs) or cold cathode fluorescent lamps (CCFLs), for example.

### <First Linearly Polarizing Plate and Second Linearly Polarizing Plate>

The first linearly polarizing plate 3a and the second linearly polarizing plate 3b may each be, for example, a product (absorptive polarizing plate) obtained by dyeing a polyvinyl alcohol film with an anisotropic material such as an iodine complex (or dye) to adsorb the anisotropic material on the polyvinyl alcohol film, and stretching the film for alignment.

The transmission axis of the first linearly polarizing plate 3a and the transmission axis of the second linearly polarizing plate 3b are preferably perpendicular to each other. The first linearly polarizing plate 3a and the second linearly polarizing plate 3b in this state are in crossed Nicols, which enables effective achievement of black display with no voltage applied to the liquid crystal layer 5 and grayscale display (intermediate grayscale display or white display) with voltage applied to the liquid crystal layer 5.

### <First Substrate>

FIG. 2 is a schematic plan view showing part of the first substrate in FIG. 1. As shown in FIG. 2, the first substrate 4a includes, in the following order toward the liquid crystal layer 5 (in FIG. 2, in the following order toward the viewer side of the figure), gate bus lines 10 each extending in the X direction, source bus lines 11 each extending in the Y direction (first direction) intersecting (in FIG. 2, perpendicular to) the X direction, a common electrode 12 (first electrode), an insulating layer 13, and pixel electrodes 14 (second electrodes). Each pixel electrode 14 is disposed in each pixel region (minimum display unit region) partitioned by the gate bus lines 10 and the source bus lines 11. In other words, a pixel region is defined by one pixel electrode 14. The common electrode 12 and the insulating layer 13 are disposed commonly (integratedly) with other pixel regions. Between the source bus lines 11 and the common electrode 12 is disposed an additional insulating layer (e.g., an insulating layer formed from an organic insulating material such as acryl) that is different from the insulating layer 13.

### (Gate Bus Line)

Examples of a material of the gate bus lines 10 include metal materials such as aluminum, copper, titanium, molybdenum, and chromium.

### (Source Bus Line)

Examples of a material of the source bus lines 11 include metal materials such as aluminum, copper, titanium, molybdenum, and chromium.

### (Common Electrode)

The common electrode 12 is connected to an external connection terminal disposed on the periphery (frame region) of the first substrate 4a. Using the common electrode 12 supplies a common potential to each pixel region.

Examples of a material of the common electrode 12 include transparent conductive materials such as indium tin oxide (ITO) and indium zinc oxide (IZO).

### (Insulating Layer)

Examples of a material of the insulating layer 13 include inorganic insulating materials such as silicon nitride (SiNₓ) and silicon oxide (SiO₂).

### (Pixel Electrode)

Each pixel electrode 14 is provided with a longitudinal portion 15 extending in the direction Q (second direction) in the pixel region. The longitudinal portion 15 is part of the electrode portion of the pixel electrode 14 and indicates a portion having a maximum extending length in a plan view of the first substrate 4a. For example, in FIG. 2, the longitudinal portion 15 corresponds to a middle portion excepting both bent ends of the pixel electrode 14.

Examples of a material of the pixel electrode 14 include transparent conductive materials such as indium tin oxide (ITO) and indium zinc oxide (IZO).

The first substrate 4a further includes thin-film transistor elements 16 as switching elements. The first substrate 4a is thus also referred to as a thin-film transistor array substrate.

Each thin-film transistor element 16 includes a source electrode 17, a semiconductor layer 18, and a drain electrode 19. The source electrode 17 is connected to the corresponding source bus line 11. The semiconductor layer 18 is connected to the source electrode 17 and the drain electrode 19. The drain electrode 19 is connected to the corresponding pixel electrode 14 through a contact hole formed in the insulating layer 13 (and the additional insulating layer that is different from the insulating layer 13). In other words, the source bus line 11 and the pixel electrode 14 are connected via the thin-film transistor element 16. The thin-film transistor element 16 is turned on or off in accordance with the gate voltage (scanning signal) applied to the corresponding gate bus line 10. When the thin-film transistor element 16 is in the on-state, a source voltage (video image signal) applied to the source bus line 11 is supplied to the pixel electrode 14 via the thin-film transistor element 16. As a result, a voltage is applied between the common electrode 12 and the pixel electrode 14 to generate a fringe electric field (transverse electric field) in the liquid crystal layer 5, whereby the alignment of liquid crystal molecules in the liquid crystal layer 5 is controlled. In other words, the liquid crystal display device 1 is an FFS mode liquid crystal display device.

Examples of the material of the semiconductor layer 18 include amorphous silicon, polycrystalline silicon, and an oxide semiconductor. Preferred among these is an oxide semiconductor in terms of low power consumption and high-speed driving. The oxide semiconductor causes a small amount of off-leakage current (leakage current of the thin-film transistor element 16 in the off-state) to achieve low power consumption and causes a large amount of on-current (current of the thin-film transistor element 16 in the on-state) to achieve high-speed driving. Examples of the oxide semiconductor include a compound formed from indium, gallium, zinc, and oxygen and a compound formed from indium, tin, zinc, and oxygen.

### <Second Substrate>

The second substrate 4b may be a color filter substrate, for example. The color filter substrate may be a product typically used in the field of liquid crystal display devices. For example, the color filter substrate may have a structure including members such as color filters, a black matrix, an over coat layer, and photospacers on the back surface side surface of a transparent substrate such as a glass substrate or a plastic substrate. The color filters may provide a single-color (e.g., red, green, blue) color filter in each pixel region. The black matrix may be disposed in a grid pattern to partition the color filters. The over coat layer functions as a flattening layer and may cover the color filters and the black matrix. The photospacers may be disposed on the back surface side surface of the over coat layer so as to be superimposed with the black matrix.

### <Liquid Crystal Layer>

Liquid crystal molecules in the liquid crystal layer 5 are horizontally aligned in the initial alignment direction P in the no-voltage applied state where no voltage is applied between the common electrode 12 and the pixel electrode 14. Meanwhile, the liquid crystal molecules are rotated in an in-plane direction to be aligned in the direction perpendicular to the extending direction Q of the longitudinal portion 15 of each pixel electrode 14 by the fringe electric field (transverse electric field) generated in the liquid crystal layer 5 in the voltage applied state where voltage is applied between the common electrode 12 and the pixel electrode 14. The “alignment direction of liquid crystal molecules” herein means the direction of the major axes of the liquid crystal molecules.

The liquid crystal molecules (liquid crystal material) may be positive liquid crystal molecules (positive liquid crystal material) having positive anisotropy of dielectric constant or negative liquid crystal molecules (negative liquid crystal material) having negative anisotropy of dielectric constant. For example, when the liquid crystal display device 1 is in the o-mode and the liquid crystal molecules are positive liquid crystal molecules, the initial alignment direction P of the liquid crystal molecules and the transmission axis of the first linearly polarizing plate 3a are perpendicular to each other.

The liquid crystal display device 1 may further include a horizontal alignment film on the liquid crystal layer 5 side surfaces of the first substrate 4a and the second substrate 4b (between the first substrate 4a and the liquid crystal layer 5 and between the second substrate 4b and the liquid crystal layer 5). Each horizontal alignment film has a function to align liquid crystal molecules in the direction parallel to a surface. The material of the horizontal alignment film may be an organic material such as polyimide or an inorganic material. A surface of the horizontal alignment film may have undergone an alignment treatment such as photoalignment treatment or rubbing treatment, preferably photoalignment treatment in terms of display quality (e.g., contrast ratio). When photoalignment treatment is performed, the surface of the horizontal alignment film is irradiated with polarized light (e.g., polarized UV light) that is polarized in the direction perpendicular to the target initial alignment direction P of the liquid crystal molecules.

In a plan view of the liquid crystal display device 1, when an angle is defined to be positive in the clockwise direction with the Y direction in which each source bus line 11 extends taken as the reference (0°), the initial alignment direction P of the liquid crystal molecules is at an angle of 0° to +5° and the extending direction Q of the longitudinal portion 15 of each pixel electrode 14 is at a negative angle.

When the initial alignment direction P of the liquid crystal molecules is at an angle of 0° to +5°, the initial alignment direction P of the liquid crystal molecules is close to the direction parallel to the Y direction in which each source bus line 11 extends. This structure prevents or reduces light leakage along each source bus line 11 caused by the phenomenon of the ray system when linearly polarized light having passed through the first linearly polarizing plate 3a from the back surface side (backlight 2 side) is incident on the first substrate 4a. The liquid crystal display device 1 thereby achieves a reduced luminance in the black display state and an improved contrast ratio. When an angle α formed by the initial alignment direction P of the liquid crystal molecules and the Y direction is greater than 5°, light leakage is caused along the source bus line 11 (and also along the longitudinal portion 15 of each pixel electrode 14 in some cases) by the phenomenon of the ray system. In order to prevent or reduce the light leakage caused by the phenomenon of the ray system, the angle α is preferably as small as possible, particularly preferably 0°.

A higher response speed of the liquid crystal display device 1 can be effectively achieved by increasing the angle formed by the initial alignment direction P of the liquid crystal molecules and the extending direction Q of the longitudinal portion 15 of each pixel electrode 14. Accordingly, in the liquid crystal display device 1, the extending direction Q of the longitudinal portion 15 of each pixel electrode 14 is brought to be at a negative angle so as to increase the angle with the initial alignment direction P of the liquid crystal molecules as much as possible.

An angle β formed by the extending direction Q of the longitudinal portion 15 of each pixel electrode 14 and the Y direction is preferably greater than 0° and 10° or smaller. When the angle β is greater than 10°, liquid crystal molecules in adjacent pixel regions are too close to each other and thus influence each other, whereby color mixture failure may be caused in the adjacent pixel regions particularly in providing pale color display (intermediate gray-scale display). One of countermeasures for avoiding this trouble is increasing the width of each source bus line 11 to increase the distance between the adjacent pixel regions. Unfortunately, this reduces the transmittance of the liquid crystal display device 1.

An angle α+β formed by the initial alignment direction P of the liquid crystal molecules and the extending direction Q of the longitudinal portion 15 of each pixel electrode 14 is preferably 10° to 15°. When the angle α+β is 10° or greater, a sufficient response speed is achieved. However, when the angle α+β is greater than 15°, the voltage at the maximum transmittance tends to shift to the high voltage side. One of the countermeasures for this trouble is increasing the voltage in the white display state to prevent or reduce a reduction in transmittance. Unfortunately, this increases the power consumption.

In Embodiment 1, in a plan view of the liquid crystal display device 1, when an angle is defined to be positive in the clockwise direction with the Y direction in which each source bus line 11 extends taken as the reference (0°), the initial alignment direction P of the liquid crystal molecules is at an angle of 0° to +5° and the extending direction Q of the longitudinal portion 15 of each pixel electrode 14 is at a negative angle. Alternatively, the following modified examples (1-1), (1-2), and (1-3) can also achieve the same effects.

(1-1) When an angle is defined to be positive in the clockwise direction with the Y direction in which each source bus line 11 extends taken as the reference (0°), the initial alignment direction P of the liquid crystal molecules is at an angle of −5° to 0° and the extending direction Q of the longitudinal portion 15 of each pixel electrode 14 is at a positive angle.

(1-2) When an angle is defined to be positive in the clockwise direction with the X direction in which each gate bus line 10 extends taken as the reference (0°), the initial alignment direction P of the liquid crystal molecules is at an angle of 0° to +5° and the extending direction Q of the longitudinal portion 15 of each pixel electrode 14 is at a negative angle.

(1-3) When an angle is defined to be positive in the clockwise direction with the X direction in which each gate bus line 10 extends taken as the reference (0°), the initial alignment direction P of the liquid crystal molecules is at an angle of −5° to 0° and the extending direction Q of the longitudinal portion 15 of each pixel electrode 14 is at a positive angle.

### Comparative Example to Embodiment 1

A liquid crystal display device of a comparative example to Embodiment 1 is the same as the liquid crystal display device of Embodiment 1 except for the shape of the pixel electrodes of the first substrate. Thus, the description of the same respects is omitted here.

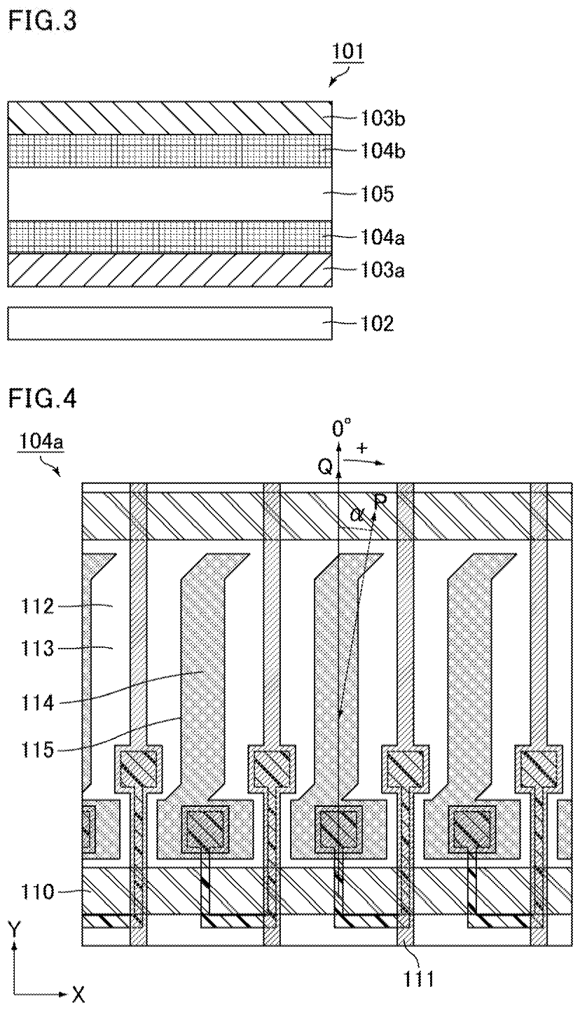

FIG. 3 is a schematic cross-sectional view showing a liquid crystal display device of the comparative example to Embodiment 1. As shown in FIG. 3, a liquid crystal display device 101 includes, in the following order from the back surface side to the viewing surface side, a backlight 102, a first linearly polarizing plate 103a, a first substrate 104a, a liquid crystal layer 105, a second substrate 104b, and a second linearly polarizing plate 103b.

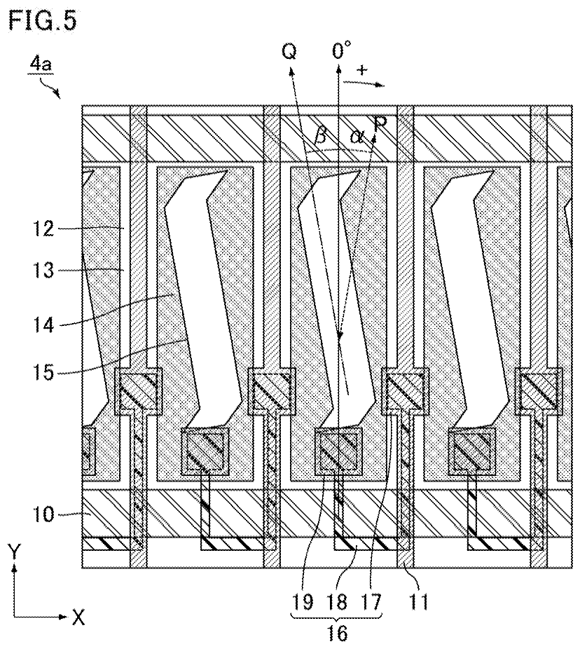

FIG. 4 is a schematic plan view showing part of the first substrate in FIG. 3. As shown in FIG. 4, the first substrate 104a includes, in the following order toward the liquid crystal layer 105 (in FIG. 4, in the following order toward the viewer side of the figure), gate bus lines 110 each extending in the X direction, source bus lines 111 each extending in the Y direction intersecting (in FIG. 4, perpendicular to) the X direction, a common electrode 112, an insulating layer 113, and pixel electrodes 114. Each pixel electrode 114 is disposed in each pixel region partitioned by the gate bus lines 110 and the source bus lines 111. The common electrode 112 and the insulating layer 113 are disposed commonly (integratedly) with other pixel regions. Between the source bus lines 111 and the common electrode 112 is disposed an additional insulating layer (e.g., an insulating layer formed from an organic insulating material such as acryl) that is different from the insulating layer 113.

Each pixel electrode 114 is provided with a longitudinal portion 115 extending in the direction Q in the pixel region.

Here, the liquid crystal display device 101 is assumed to be applied to a smartphone that requires a high response speed, for example. In a plan view of the liquid crystal display device 101, when an angle is defined to be positive in the clockwise direction with the Y direction in which each source bus line 111 extends taken as the reference (0°), the initial alignment direction P of the liquid crystal molecules is set at an angle of about +6° to about +15° and the extending direction Q of the longitudinal portion 115 of each pixel electrode 114 is set at an angle of 0°, i.e., in the Y direction.

In the liquid crystal display device 101, when linearly polarized light having passed through the first linearly polarizing plate 103a from the back surface side (backlight 102 side) is incident on the first substrate 104a, the polarized direction of the linearly polarized light is parallel or perpendicular to the initial alignment direction P of the liquid crystal molecules and thus is significantly inclined to the extending direction of each source bus line 111. As a result, the phenomenon of the ray system occurs when the linearly polarized light passes through the source bus line 111. For example, when linearly polarized light incident on the first substrate 104a from the back surface side has a polarized direction parallel to the initial alignment direction P of the liquid crystal molecules and the linearly polarized light passes through the source bus line 111, the polarized direction is rotated from the initial alignment direction P of the liquid crystal molecules to the Y direction in which each source bus line 111 extends by the phenomenon of the ray system. As a result, linearly polarized light having passed through the source bus line 111 passes through the second linearly polarizing plate 103b (e.g., transmission axis: perpendicular to the transmission axis of the first linearly polarizing plate 103a) without being absorbed. Accordingly, light leakage occurs along the source bus line 111 in the black display state to reduce the contrast ratio.

### Embodiment 2

A liquid crystal display device of Embodiment 2 is the same as the liquid crystal display device of Embodiment 1 except for the arrangement and the shapes of the common electrode and the pixel electrodes of the first substrate. Thus, the description of the same respects is omitted here.

The liquid crystal display device of Embodiment 2 has the same schematic cross-sectional view as in FIG. 1. FIG. 5 is a schematic plan view showing part of the first substrate in the liquid crystal display device of Embodiment 2. As shown in FIG. 5, the first substrate 4a includes, in the following order toward the liquid crystal layer 5 (in FIG. 5, in the following order toward the viewer side of the figure), the gate bus lines 10 each extending in the X direction, the source bus lines 11 each extending in the Y direction (first direction) intersecting (in FIG. 5, perpendicular to) the X direction, the pixel electrodes 14 (first electrodes), the insulating layer 13, and the common electrode 12 (second electrode). Each pixel electrode 14 is disposed in each pixel region partitioned by the gate bus lines 10 and the source bus lines 11. The common electrode 12 and the insulating layer 13 are disposed commonly (integratedly) with other pixel regions. Between the source bus lines 11 and the pixel electrodes 14 is disposed an additional insulating layer (e.g., an insulating layer formed from an organic insulating material such as acryl) that is different from the insulating layer 13.

The common electrode 12 is provided with longitudinal portions 15 each extending in the direction Q (second direction) in the pixel region. Each longitudinal portion 15 is part of an aperture (slit) formed in the common electrode 12 and indicates a portion having a maximum extending length in a plan view of the first substrate 4a. For example, in FIG. 5, the longitudinal portions 15 each correspond to a middle portion excepting both bent ends of each aperture formed in the common electrode 12.

In a plan view of the liquid crystal display device 1, when an angle is defined to be positive in the clockwise direction with the Y direction in which each source bus line 11 extends taken as the reference (0°), the initial alignment direction P of the liquid crystal molecules is at an angle of 0° to +5° and the extending direction Q of each longitudinal portion 15 of the common electrode 12 is at a negative angle.

When the initial alignment direction P of the liquid crystal molecules is at an angle of 0° to +5°, the initial alignment direction P of the liquid crystal molecules is close to the direction parallel to the Y direction in which each source bus line 11 extends. This structure prevents or reduces light leakage along each source bus line 11 caused by the phenomenon of the ray system as in Embodiment 1 when linearly polarized light having passed through the first linearly polarizing plate 3a from the back surface side (backlight 2 side) is incident on the first substrate 4a. The liquid crystal display device 1 thereby achieves a reduced luminance in the black display state and an improved contrast ratio. When the angle α formed by the initial alignment direction P of the liquid crystal molecules and the Y direction is greater than 5°, light leakage is caused along the source bus line 11 (and also along each longitudinal portion 15 of the common electrode 12 in some cases) by the phenomenon of the ray system. In order to prevent or reduce the light leakage caused by the phenomenon of the ray system, the angle α is preferably as small as possible, particularly preferably 0°.

Bringing the extending direction Q of each longitudinal portion 15 of the common electrode 12 to be at a negative angle can increase the angle with the initial alignment direction P of the liquid crystal molecules as much as possible and thereby can improve the response speed of the liquid crystal display device 1 as in Embodiment 1.

The angle β formed by the extending direction Q of each longitudinal portion 15 of the common electrode 12 and the Y direction is preferably greater than 0° and 10° or smaller. When the angle β is greater than 10°, liquid crystal molecules in adjacent pixel regions are too close to each other and thus influence each other, whereby color mixture failure may be caused in the adjacent pixel regions particularly in providing pale color display (intermediate gray-scale display). One of countermeasures for avoiding this trouble is increasing the width of each source bus line 11 to increase the distance between the adjacent pixel regions. Unfortunately, this reduces the transmittance of the liquid crystal display device 1.

An angle α+β formed by the initial alignment direction P of the liquid crystal molecules and the extending direction Q of each longitudinal portion 15 of the common electrode 12 is preferably 10° to 15°. When the angle α+β is 10° or greater, a sufficient response speed is achieved. However, when the angle α+β is greater than 15°, the voltage at the maximum transmittance tends to shift to the high voltage side. One of the countermeasures for this trouble is increasing the voltage in the white display state to prevent or reduce a reduction in transmittance. Unfortunately, this increases the power consumption.

In Embodiment 2, in a plan view of the liquid crystal display device 1, when an angle is defined to be positive in the clockwise direction with the Y direction in which each source bus line 11 extends taken as the reference (0°), the initial alignment direction P of the liquid crystal molecules is at an angle of 0° to +5° and the extending direction Q of each longitudinal portion 15 of the common electrode 12 is at a negative angle. Alternatively, the following modified examples (2-1), (2-2), and (2-3) can also achieve the same effects.

(2-1) When an angle is defined to be positive in the clockwise direction with the Y direction in which each source bus line 11 extends taken as the reference (0°), the initial alignment direction P of the liquid crystal molecules is at an angle of −5° to 0° and the extending direction Q of each longitudinal portion 15 of the common electrode 12 is at a positive angle.

(2-2) When an angle is defined to be positive in the clockwise direction with the X direction in which each gate bus line 10 extends taken as the reference (0°), the initial alignment direction P of the liquid crystal molecules is at an angle of 0° to +5° and the extending direction Q of each longitudinal portion 15 of the common electrode 12 is at a negative angle.

(2-3) When an angle is defined to be positive in the clockwise direction with the X direction in which each gate bus line 10 extends taken as the reference (0°), the initial alignment direction P of the liquid crystal molecules is at an angle of −5° to 0° and the extending direction Q of each longitudinal portion 15 of the common electrode 12 is at a positive angle.

### Comparative Example to Embodiment 2

A liquid crystal display device of a comparative example to Embodiment 2 is the same as the liquid crystal display device of the comparative example to Embodiment 1 except for the arrangement and the shapes of the common electrode and the pixel electrodes of the first substrate (the same as the liquid crystal display device of Embodiment 2 except for the shape of the common electrode of the first substrate). Thus, the description of the same respects is omitted here.

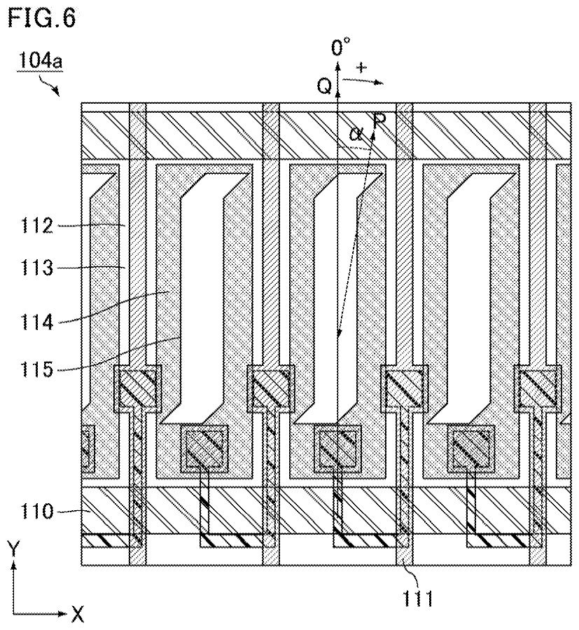

The liquid crystal display device of the comparative example to Embodiment 2 has the same schematic cross-sectional view as in FIG. 3. FIG. 6 is a schematic plan view showing part of the first substrate in the liquid crystal display device of the comparative example to Embodiment 2. As shown in FIG. 6, the first substrate 104a includes, in the following order toward the liquid crystal layer 105 (in FIG. 6, in the following order toward the viewer side of the figure), the gate bus lines 110 each extending in the X direction, the source bus lines 111 each extending in the Y direction intersecting (in FIG. 6, perpendicular to) the X direction, the pixel electrodes 114, the insulating layer 113, and the common electrode 112. Each pixel electrode 114 is disposed in each pixel region partitioned by the gate bus lines 110 and the source bus lines 111. The common electrode 112 and the insulating layer 113 are disposed commonly (integratedly) with other pixel regions. Between the source bus lines 111 and the pixel electrodes 114 is disposed an additional insulating layer (e.g., an insulating layer formed from an organic insulating material such as acryl) that is different from the insulating layer 113.

The common electrode 112 is provided with longitudinal portions 115 each extending in the direction Q in the pixel region.

Here, the liquid crystal display device 101 is assumed to be applied to a smartphone that requires a high response speed, for example. In a plan view of the liquid crystal display device 101, when an angle is defined to be positive in the clockwise direction with the Y direction in which each source bus line 111 extends taken as the reference (0°), the initial alignment direction P of the liquid crystal molecules is set at an angle of about +6° to about +15° and the extending direction Q of each longitudinal portion 115 of the common electrode 112 is set at an angle of 0°, i.e., in the Y direction.

In the liquid crystal display device 101, when linearly polarized light having passed through the first linearly polarizing plate 103a from the back surface side (backlight 102 side) is incident on the first substrate 104a, the polarized direction of the linearly polarized light is parallel or perpendicular to the initial alignment direction P of the liquid crystal molecules and thus is significantly inclined to the extending direction of each source bus line 111. As a result, the phenomenon of the ray system occurs when the linearly polarized light passes through the source bus line 111ii. For example, when linearly polarized light incident on the first substrate 104a from the back surface side has a polarized direction parallel to the initial alignment direction P of the liquid crystal molecules and the linearly polarized light passes through the source bus line 111, the polarized direction is rotated from the initial alignment direction P of the liquid crystal molecules to the Y direction in which each source bus line 111 extends by the phenomenon of the ray system. As a result, linearly polarized light having passed through the source bus line 111 passes through the second linearly polarizing plate 103b (e.g., transmission axis: perpendicular to the transmission axis of the first linearly polarizing plate 103a) without being absorbed. Accordingly, light leakage occurs along the source bus line 111 in the black display state to reduce the contrast ratio.

What is claimed is:

1. A liquid crystal display device comprising:
a first substrate;
a second substrate facing the first substrate; and
a liquid crystal layer that is sandwiched between the first substrate and the second substrate and contains liquid crystal molecules,
the first substrate including, in the following order toward the liquid crystal layer, a bus line extending in a first direction, a first electrode, an insulating layer, and a second electrode,
the second electrode being provided with a longitudinal portion extending in a second direction in a pixel region,
an initial alignment direction of the liquid crystal molecules and the second direction satisfying the following relation (A) or (B) when an angle is defined to be positive in a clockwise direction with the first direction taken as a reference:
(A) the initial alignment direction of the liquid crystal molecules is at an angle of 0° to +5° and the second direction is at a negative angle; and
(B) the initial alignment direction of the liquid crystal molecules is at an angle of −5° to 0° and the second direction is at a positive angle.

2. The liquid crystal display device according to claim 1,
wherein the longitudinal portion is part of an electrode portion of the second electrode.

3. The liquid crystal display device according to claim 1,
wherein the longitudinal portion is part of an aperture formed in the second electrode.

4. The liquid crystal display device according to claim 1,
wherein the first direction and the second direction form an angle of greater than 0° and 10° or smaller.

5. The liquid crystal display device according to claim 1,
wherein the initial alignment direction of the liquid crystal molecules and the second direction form an angle of 10° to 15°.
